(19) United States
(12) Patent Application Publication
(10) Pub. No.: US 2016/0305181 A1
(43) Pub. Date: Oct. 20, 2016

(54) AUTOMATIC SAFETY WINDOW APPARATUS AND SYSTEM

(71) Applicants: Wilmar Valverde, Seymour (CT); Paul R. Hebert, Manchester, CT (US); Kevin O'Neill, Branford, CT (US)

(72) Inventors: Wilmar Valverde, Seymour (CT); Paul R. Hebert, Manchester, CT (US); Kevin O'Neill, Branford, CT (US)

(21) Appl. No.: 15/070,188

(22) Filed: Mar. 15, 2016

Related U.S. Application Data
(60) Provisional application No. 62/147,163, filed on Apr. 14, 2015.

(51) Int. Cl. E05F 15/72; G08B 21/18; F24F 11/00

(52) U.S. Cl. CPC E05F 15/72; F24F 11/0079; G08B 21/182; E05F 2700/00; E05Y 2400/44; E05Y 2400/52; E05Y 2900/148; F24F 2011/0027; F24F 11/0017

(57) ABSTRACT

A an automatic safety window apparatus comprising: a window unit configured to attach to the interior of a window, the window unit comprising: an actuator; a linkage in operable communication with the actuator, and configured to attach to a window sash; where the actuator is configured to open the window sash. An automatic safety window apparatus comprising: a window unit configured to attach to the interior of a window, the window unit comprising: an actuator; an alarm and transmitter unit in signal communication with the actuator; a linkage in operable communication with the actuator, and configured to attach to a window sash; where the actuator is configured to open the window sash when the alarm and transmitter unit detects gas levels above a threshold level. An automatic safety window system comprising: a window, the window comprising: a first window jam; a window head abutting the first window jam; a second window jam abutting the window head; a top sash vertically slideable between the first and second window jams; a bottom sash vertically slideable between the first and second window jams; a window unit configured to attach to the interior of the window, the window unit comprising: an actuator; a linkage in operable communication with the actuator, and attached to the top sash; a receiver in signal communication with the actuator; a battery power source in communication with the receiver and the actuator; a fan connected to the receiver, an alarm and transmitter unit located remotely from the window unit, the alarm and transmitter unit configured to transmit an open window signal to the receiver when a threshold level of a gas is reached and to initiate an alarm; and where the fan is configured to activate when the receiver receives an open window signal from the alarm and transmitter unit and where the fan is configured to blow air from outside of a room the automatic safety window apparatus is installed in, through the window, into the room; and where the receiver is configured to send a signal to the actuator to open the top sash when an open window signal is received from the alarm and transmitter unit.

### CROSS-REFERENCES

This patent application claims the benefit of U.S. Provisional Patent Application No. 62/147,163 by inventors Wilmar Valverde and Paul Hebert entitled “SAFETY WINDOW AND OPERATING MECHANISM THEREFORE,” filed on Apr. 14, 2015, and which provisional application is fully incorporated by reference herein.

### TECHNICAL FIELD

The present invention relates to an automatic safety window apparatus and system and more specifically to an automatic safety window apparatus and system that can detect unsafe levels of gases, and automatically open one or more windows to prevent deadly levels of gases from building up.

### BACKGROUND

Many people are killed when unsafe levels of carbon monoxide (CO) and/or natural gas build up in the homes. CO detectors and Natural Gas detectors can detect these gases, but if people are already incapacitated, the audible alarms will do little good.

Thus there is a need for an automatic safety window apparatus and system that overcomes the above listed and other disadvantages.

### SUMMARY OF THE INVENTION

The invention relates to an automatic safety window apparatus comprising: a window unit configured to attach to the interior of a window, the window unit comprising: an actuator; a linkage in operable communication with the actuator, and configured to attach to a window sash; where the actuator is configured to open the window sash.

The invention also relates to an automatic safety window apparatus comprising: a window unit configured to attach to the interior of a window, the window unit comprising: an actuator; an alarm and transmitter unit in signal communication with the actuator; a linkage in operable communication with the actuator, and configured to attach to a window sash; where the actuator is configured to open the window sash when the alarm and transmitter unit detects gas levels above a threshold level.

The invention, in addition, relates to an automatic safety window system comprising: a window, the window comprising: a first window jam; a window head abutting the first window jam; a second window jam abutting the window head; a top sash vertically slideable between the first and second window jams; a bottom sash vertically slideable between the first and second window jams; a window unit configured to attach to the interior of the window, the window unit comprising: an actuator; a linkage in operable communication with the actuator, and attached to the top sash; a receiver in signal communication with the actuator; a battery power source in communication with the receiver and the actuator; a fan connected to the receiver, an alarm and transmitter unit located remotely from the window unit, the alarm and transmitter unit configured to transmit an open window signal to the receiver when a threshold level of a gas is reached and to initiate an alarm; and where the fan is configured to activate when the receiver receives an open window signal from the alarm and transmitter unit and where the fan is configured to blow air from outside of a room the automatic safety window apparatus is installed in, through the window, into the room; and where the receiver is configured to send a signal to the actuator to open the top sash when an open window signal is received from the alarm and transmitter unit.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of the automatic safety window apparatus;

FIG. 2 is a close up perspective view of the alarm and transmitter unit;

FIG. 3 is a front view of the alarm and transmitter unit from FIG. 2;

FIG. 4 is a front view of the automatic safety window apparatus;

FIG. 5 is a perspective view of the automatic safety window apparatus with the covers removed;

FIG. 6 is a front view of the automatic safety window apparatus from FIG. 5;

FIG. 7 is a front view of the automatic safety window apparatus with the top sash opened;

FIG. 8 side view of the automatic safety window apparatus; and

FIG. 9 is a side view of the automatic safety window apparatus with the top sash opened.

### DETAILED DESCRIPTION OF THE INVENTION

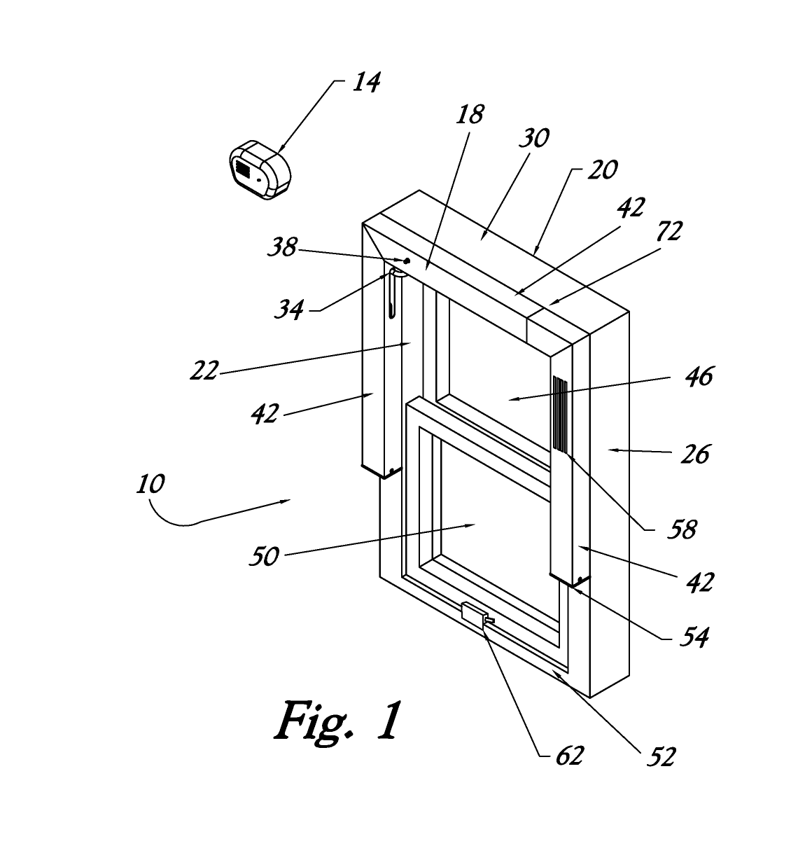

FIG. 1 shows a perspective view of the automatic safety window apparatus 10. The apparatus comprises an alarm and transmitter unit 14. The alarm and transmitter unit 14 may be configured to sound an alarm when it senses a specified level of a particular gas. The gas may be CO or natural gas, or smoke. In addition, when the specified level of gas is sensed, the unit 14 will transmit a signal to the window unit 18. The alarm and transmitter unit 14 may be installed anywhere in the home or building, either on a wall or ceiling. In one embodiment, the alarm and transmitter unit 18 will be located near a source of potentially dangerous gas. The window unit 18 attaches to a window 20. The window 20 may comprise window jams 22, 26, window head 30 (top of window frame); top sash 46, bottom sash 50, and window lock 62 for bottom sash 50, and a window sill 52. The automatic safety window apparatus 10 may be configured to attach to double hung windows such as window 20. However, the automatic safety window apparatus 10 may be configured to attach to any suitable window type. The window unit may attach to one or more of the window jams 22, 26, and/or the window head 30. The window unit 18 comprises a window opening linkage 34 and a reset button 38. The window unit 18 may comprise one more covers 42. The window unit may have a power connection 54 and an optional air flow vent 58. In addition, the automatic safety window apparatus 10 may also have an adjustable sliding joint 78 in the cover 42. This joint 78 allows the window unit 14 to be adjustable to fit different width windows 20.

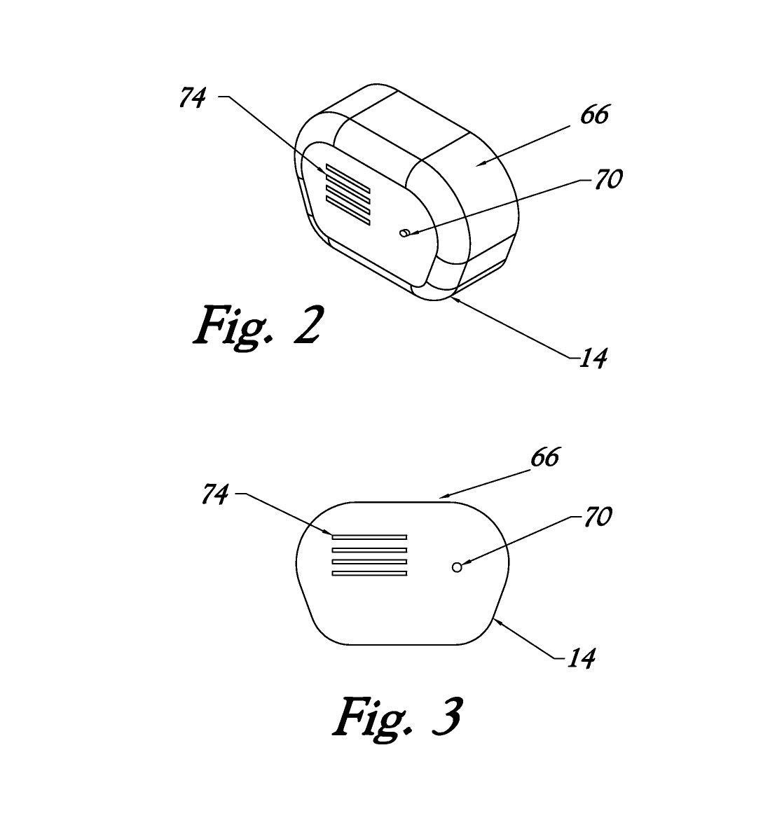

FIG. 2 shows a close up perspective view of the alarm and transmitter unit 14. The unit may comprise an alarm and transmitter unit housing 66, an alarm and transmitter unit reset button 70, and an inlet 74 to allow the unit 14 to determine the level of a particular gas or gasses.

FIG. 3 is a front view of the alarm and transmitter unit 14 from FIG. 2. Please note that one of ordinary skill in the art will recognize that in other embodiments, that the alarm and transmitter unit 14 may be incorporated into the window unit 18, so that the window unit 18 is generally a self-contained unit without the need to separately install an alarm and transmitter unit 14.

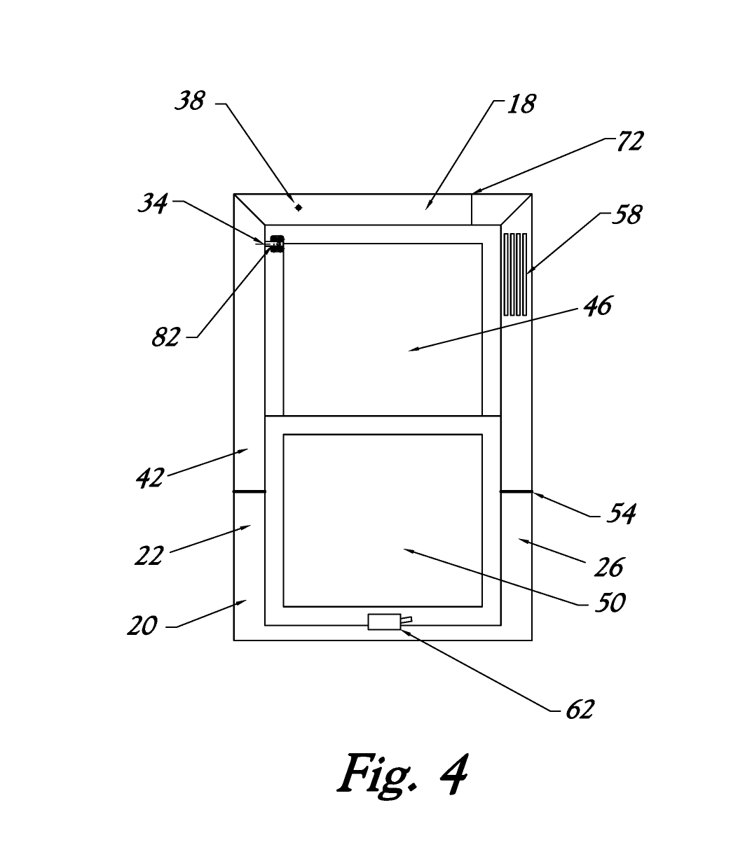

FIG. 4 is a front view of the automatic safety window apparatus 10 from FIG. 1. In this view, the window sash connector 82 is shown. The window sash connector 82 is in operable communication with window opening linkage 34. The sash connector 82 is attached to the top sash 46 in this embodiment.

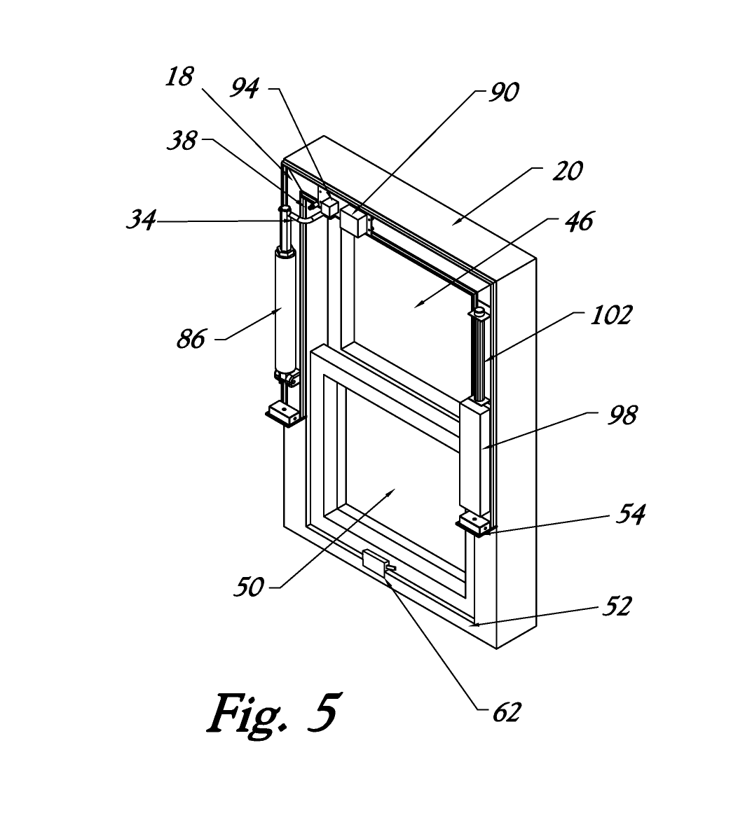

FIG. 5 is a perspective view of the automatic safety window apparatus 10 with the covers 42 removed. In this view an actuator 86, which comprises the automatic safety window apparatus 10 is shown. The actuator may be any suitable device that provides linear movement, including and not limited to an electric cylinder. The actuator 86 is configured to move the linkage 34, window sash connector 82, and the top sash 46. Thus, the actuator 86 can open the window 20 (by lowering the top sash 46 in one embodiment) to prevent a deadly accumulation of deadly gases or smoke. Also comprising the automatic safety window apparatus 10 is a receiver 90 and solid state relay 94 configured to activate the actuator 86. The receiver 90 is in signal communication with the alarm and transmitter unit 14. In some embodiments, the alarm and transmitter unit 18 may be configured to be in signal communication with two or more receivers 90 in two or more window units 18. In one embodiment the receiver 90 is in wireless communication with the alarm and transmitter unit 14, but in other embodiments they may be in wired communication. Thus, when the alarm and transmitter unit 14 detects an unsafe level of gas, the alarm goes off in the unit 14, and a signal is sent from the unit 14 to the receiver 90, which in turn communicates with the relay 94 which activates the actuator 86 which lowers the top sash 46. An optional power supply 98 is shown in communication with the actuator 86, relate 94, and recover 90. The power supply may be a battery, either rechargeable, or replaceable battery after a length of time. In other embodiments, the window unit 18 may be powered via the power connection 54 to an electrical line. The window unit 18 may also comprise a fan 102 in electrical communication with the power supply 98 or the power connection 54. The fan 102 may be any suitable fan, including and not limited to a vertical cross-flow fan. The fan 102 may be configured to pull outside air into the room where the window unit 18 is located via the open window. In other embodiments, the fan 102 may be configured to take air out of the room where the window unit 18 is located and direct the room air to the outdoors via the open window.

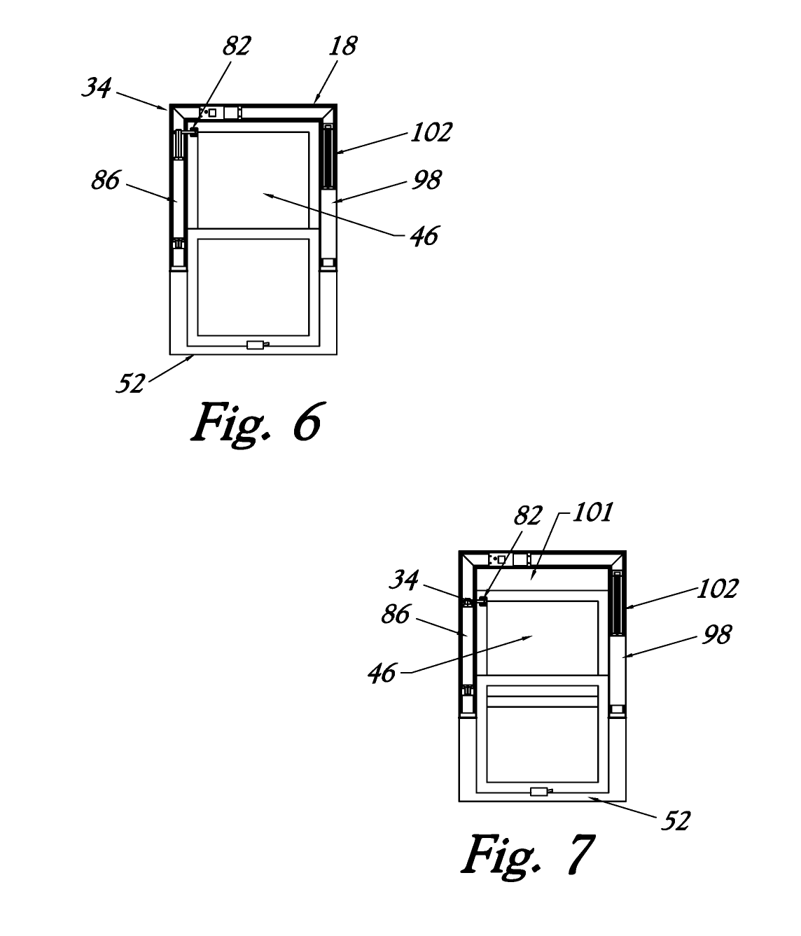

FIG. 6 shows a front view of the window unit 18 with the covers 42 removed. In this figure, the top sash 46 is in a closed position.

FIG. 7 shows a front view of the window unit 18 with the covers 42 removed. In this figure, the top sash is in an opened position with an opening 106 made by the lowering of the top sash 46 by the actuator 86, linkage 34 and sash connector 82.

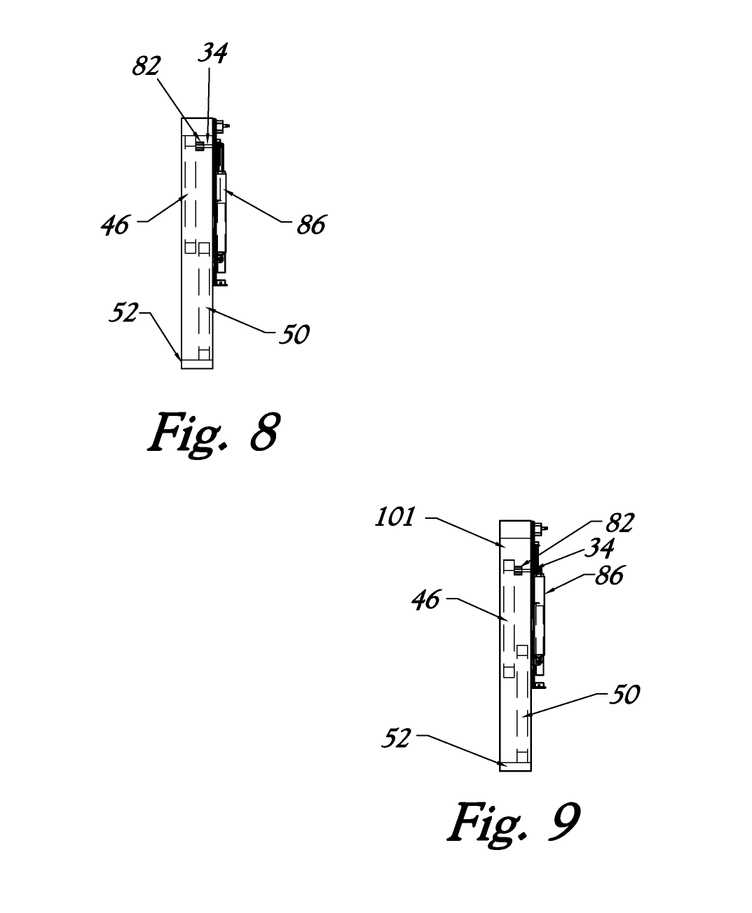

FIG. 8 shows a side view cutaway view of the window 20 and window unit 18. In this view the top sash 46 is closed.

FIG. 9 shows a side view cutaway view of the window 20 and window unit 18. In this view the top sash 46 is opened, showing an opening 102 in the window 20 to let clean outside air into the room.

In one embodiment, the automatic safety window apparatus, and system may be attached to the interior of an existing window frame that operates wirelessly with CO and/or Natural Gas alarms. When the alarm is activated a signal may be sent from the alarm to a receiver in the window unit and then that triggers an electric cylinder to drop the upper window pane about 4 inches to about 6 inches. This allows the evacuation of the gases from the room, in one embodiment a bedroom or a plurality of bedrooms. A drop of 1000 to 2000 particles per million may allow a person to survive and leave the building. The size of the building and location of the gas sources will determine the location and number of alarms and window units required. The alarm may activate at 275 ppm and the window would open. Based on testing on this invention, the parts per million never exceeded 275 ppm. A remote main power supply with a backup battery to power up to 4 windows and alarms may be supplied. A lot of these types of gas leaks or CO accidents happen when there is a loss of power in the building, so the backup battery may be a an important part of this system. There is also an optional fan built into the frame to aid in evacuating the air through the window opening. This system can also be integrated in the window frame as a self-contained unit for new window installation or as an interior surface applied unit and these same systems and also be adapted to commercial casement windows for schools, offices and apartment buildings.

In one experimental test, the exhaust of a car with a V8 engine was connected to a chamber, the chamber was meant to represent a bedroom. 440 Particles per Million (ppm) of CO was exiting at the exhaust pipe of the car. The chamber size was 10′×10′×7′9″. The temperature in chamber was 62° F. at the beginning of the test. The room had 4 ppm of CO before the car was running. The alarm activated when an index gauge read 272 ppm, and a window was open about 4 inches. The chamber never reaches higher than 272 ppm. Three consecutive tests were run with the internal ppm triggering the alarm from 247 to 272 ppm. The ppm within the room on all 3 tests dropped to 200 ppm in 20 minutes and to 129 ppm in 30 minutes. Gage reading outside window when the alarm activated and the window opened 4 inches went from 151 ppm to 40 ppm in 13 minutes without an exhaust fans. Volume of air exiting the window was between 53 and 125 cubic feet per minute. For the 4th test, air fans were added blowing inward into the chamber. The room temperature was 68° ; it dropped from 220 ppm upon opening the window to 115 ppm in 15 minutes.

This invention has many advantages. It automatically opens a room window when a threshold level of gas is detected, thereby saving the life of whoever is the room, and allowing that person to escape the room. The invention may have a rechargeable battery to power the device, thus in the event of a power failure the device will still work. The invention may have a remote alarm and transmitter unit that may be located near a gas source, in order to provide early detection of unsafe gas levels, and early opening of the window. The invention may be attached to almost any residential or commercial window in an aftermarket fashion. The invention not only provides an alarm, but will provide proactive action, and open a window in a person's bedroom. The invention can monitor the building twenty-four hours a day, seven days a week, whether or not someone is in the building or not, and open the windows if required.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. An automatic safety window apparatus comprising:
a window unit configured to attach to the interior of a window, the window unit comprising:
an actuator;
a linkage in operable communication with the actuator, and configured to attach to a window sash;
wherein the actuator is configured to open the window sash.

2. The automatic safety window apparatus of claim 1 further comprising:
an alarm and transmitter unit located remotely from the window unit, the alarm and transmitter unit configured to transmit an open window signal when a threshold level of a gas is reached and to initiate an alarm;
and where the window unit further comprises:
a receiver in signal communication with the actuator and in wireless communication with the alarm and transmitter unit, the receiver configured to transmit a signal to the actuator to open the window sash when the receiver receives an open window signal from the alarm and transmitter unit.

3. The automatic safety window apparatus of claim 2, wherein the window unit further comprises:
a battery power source in communication with the receiver and the actuator.

4. The automatic safety window apparatus of claim 3, wherein the battery power source is rechargeable.

5. The automatic safety window apparatus of claim 2, wherein the window unit has a power connection in electrical communication with the receiver and actuator and configured to connect to a buildings power source.

6. The automatic safety window apparatus of claim 2, wherein the window unit further comprises:
a fan connected to the receiver and configured to activate when the receiver receives an open window signal from the alarm and transmitter unit.

7. The automatic safety window apparatus of claim 6, wherein the fan is a vertical cross-flow fan.

8. The automatic safety window apparatus of claim 6, wherein the fan is configured to blow air from outside of a room the automatic safety window apparatus is installed in, through the window, into the room.

9. The automatic safety window apparatus of claim 6, wherein the fan is configured to blow air from inside a room the automatic safety window apparatus is installed in, out the opened window.

10. An automatic safety window apparatus comprising:
a window unit configured to attach to the interior of a window, the window unit comprising:
an actuator;
an alarm and transmitter unit in signal communication with the actuator;
a linkage in operable communication with the actuator, and configured to attach to a window sash;
wherein the actuator is configured to open the window sash when the alarm and transmitter unit detects gas levels above a threshold level.

11. The automatic safety window apparatus of claim 10, wherein the window unit further comprises:
a battery power source in communication with the alarm and transmitter unit, and the actuator.

12. The automatic safety window apparatus of claim 11, wherein the battery power source is rechargeable.

13. The automatic safety window apparatus of claim 10, wherein the window unit has a power connection in electrical communication with the alarm and transmitter unit and actuator and configured to connect to a buildings power source.

14. The automatic safety window apparatus of claim 2, wherein the window unit further comprises:
a fan connected to the alarm and transmitter unit and configured to activate when the alarm and transmitter unit detects gas levels above a threshold level.

15. The automatic safety window apparatus of claim 14, wherein the fan is a vertical cross-flow fan.

16. The automatic safety window apparatus of claim 14, wherein the fan is configured to blow air from outside of a room the automatic safety window apparatus is installed in, through the window, into the room.

17. The automatic safety window apparatus of claim 14, wherein the fan is configured to blow air from inside a room the automatic safety window apparatus is installed in, out the opened window.

18. An automatic safety window system comprising:
a window, the window comprising:
a first window jam;
a window head abutting the first window jam;
a second window jam abutting the window head;
a top sash vertically slideable between the first and second window jams;
a bottom sash vertically slideable between the first and second window jams;
a window unit configured to attach to the interior of the window, the window unit comprising:
an actuator;
a linkage in operable communication with the actuator, and attached to the top sash;
a receiver in signal communication with the actuator;
a battery power source in communication with the receiver and the actuator;
a fan connected to the receiver,
an alarm and transmitter unit located remotely from the window unit, the alarm and transmitter unit configured to transmit an open window signal to the receiver when a threshold level of a gas is reached and to initiate an alarm; and
wherein the fan is configured to activate when the receiver receives an open window signal from the alarm and transmitter unit and wherein the fan is configured to blow air from outside of a room the automatic safety window apparatus is installed in, through the window, into the room; and wherein the receiver is configured to send a signal to the actuator to open the top sash when an open window signal is received from the alarm and transmitter unit.
